(19) United States
(12) Patent Application Publication
(10) Pub. No.: US 2026/0309837 A1
(43) Pub. Date: Oct. 8, 2026

(54) SENSING NODE, AND CONTROL NODE

(71) Applicant: Telefonaktiebolaget LM Ericsson (publ), Stockholm (SE)

(72) Inventors: Julia EQUI, ESPOO (FI); Bikramjit SINGH, RAASEPORI (FI)

(21) Appl. No.: 19/491,469

(22) PCT Filed: Jun. 15, 2023
(86) PCT No.: PCT/SE2023/050599

§ 371 Date: Dec. 9, 2025

(51) Int. Cl. G01S 7/00; G01S 13/00; G01S 13/06; H04L 5/00; H04W 4/02

(52) U.S. Cl. CPC G01S 7/006; G01S 13/003; G01S 13/06; H04L 5/0053; H04W 4/02

(57) ABSTRACT

A method by a sensing node includes receiving (800) control signaling from a control node that indicates which part of a transmission is to be used for sensing. The method decodes (802) a received transmission to obtain user plane data and/or control plane data. The method senses (804) properties of the part of the received transmission indicated by the control signaling, to determine presence of an object and/or to localize location of the object. A method by a control node includes determining (900) which part of a transmission is to be used by a sensing node for sensing properties, and sending (902) control signaling that indicates at least which part of the transmission is to be used by the sensing node for the sensing of properties. A corresponding sensing node, control node, system and method by a system are disclosed.

### TECHNICAL FIELD

The present disclosure relates to sensing. In particular, the embodiments relate to a control node, a sensing node, a system and methods thereof. Computer programs and a computer program product are also disclosed.

### BACKGROUND

Recently, the system architectures (SA1 and SA2) groups of the 3rd Generation Partnership Project (3GPP) have defined study items to identify use cases and architectural enhancements that will enable joint communications and sensing (JCAS) in cellular networks in references [1], [2], and [3].

Sensing using cellular networks can be performed in a monostatic setting, when the transmitter and the receiver sensing antennas are located in the same node, and in a multi-static setting, when the transmitter and the receiver sensing antennas are located in different nodes. FIGS. 1a, 1b, 1c, 1d, 1e, and 1f illustrate different radar settings that can be deployed using New Radio (NR) base station(s) (BS(s)), denoted by gNB, and user equipment(s) (UE(s)) as presented in [3]. The goal is to detect and localize a target(s) which is/are, in general, is a non-connected object (such as a pedestrian, an animal, etc).

In FIGS. 1a and 1e, the monostatic setting refers to the setting for which the sensing transmitter antenna array is co-located with the sensing receiver antenna array at the gNB or the UE, respectively in FIGS. 1 (1) and (5).

In FIGS. 1a, 1b, 1c, 1d, and 1f, the bi-static setting corresponds to the case where the sensing transmitter antenna array is located at a different gNB/UE node as compared to the sensing receiver antenna array.

It is also noted that FIGS. 1a, 1b, 1c, 1d, 1e, and 1f depict bi-static sensing configurations that can be extended to the multi-static case with one or several sensing transmitter/receiver antenna arrays.

A passive object is an object which does not have the operational capability to obtain communication connectivity. In some cases, the passive object is moving (e.g., cars without a cellular sim card or a person without a mobile phone, animals, vulnerable road users without a UE, etc.).

The passive object can be stationary at a given time, but its position can change over time (for example, person not moving, sleeping animal, etc.). It should be differentiated from other objects in the environments such as walls, buildings, or other static objects belonging to the environment.

In general, a passive object is any object whose presence/position needs to be known by the network in a given use case or scenario, but it cannot communicate with the network through the communication link.s

The existing 3GPP Radio Access Network (RAN) specification provides the framework for data or voice transmission over the wireless medium. 3GPP has introduced functionalities in its specification to support various kinds of data transmissions needs which have evolved over time, which could depend on reliability, latency budget, traffic pattern, etc. Typical examples of wireless traffic are Ultra-Reliable Low Latency Communication (URLLC), enhanced Mobile BroadBand (eMBB), Extended Reality (XR), Internet of Things (IoT) traffic, etc.

Recently, the system architectures (SA1 and SA2) groups of the 3GPP have defined study items to identify use cases and architectural enhancements that will enable joint communications and sensing (JCAS) in cellular networks [1], [3]. Sensing needs to be performed also for passive objects to identify/assess the environment, identify/detect the clutters. For road safety cases, it is necessary to identify any vulnerable road user, an animal, or other object (even without cellular connectivity) and alert the driver or the control entity (in the case of autonomous driving). This use case is totally different from legacy use case of data transmission.

This raises many options to 3GPP in future design of the communication framework that can support JCAS framework on the top of the legacy and primary use case of data transmission. Currently, the signaling procedures are designed to allocate resources in uplink (UL) or downlink (DL) for communication data transmissions.

Fundamentally, JCAS refers to a framework designed to perform communication and sensing jointly. An unsolved issues arises with how to support both frameworks (communication and JCAS) given that the existing signaling procedures are designed to transmit communication data, which has associated protocols over different layers. For instance, Hybrid Automatic Repeat request (HARQ) retransmissions at Medium Access Control (MAC), Radio Link Control (RLC) retransmissions at RLC based on decoding of data or Transport block (TB), and such processes may not apply to sensing signal transmissions related to JCAS use cases and scenarios.

### SUMMARY

An object of the invention is to provide an improved framework for sensing. Some embodiments disclosed herein are directed to a method by a sensing node. The method includes receiving control signaling from a control node that indicates which part of a transmission is to be used for sensing. The method decodes a received transmission from the control node to obtain user plane data and/or control plane data. The method senses properties of the part of the received transmission indicated by the control signaling, to determine presence of an object and/or to localize location of the object.

Some other related embodiments are directed to a method by a control node. The method includes determining which part of a transmission is to be used by a sensing node for sensing properties to determine presence of an object and/or to localize location of the object. The method sends control signaling that indicates at least which part of the transmission is to be used by the sensing node for the sensing of properties to determine presence of the object and/or to localize location of the object.

Some other related embodiments are directed a sensing node that includes circuitry operative to receive control signaling from a control node that indicates part of a transmission is to be used for sensing. The circuitry is further operative to decode a received transmission to obtain user plane data and/or control plane data, and to sense properties of the part of the received transmission indicated by the control signaling, to determine presence of an object and/or to localize location of the object.

Some other related embodiments are directed a control node that includes circuitry operative to determine which part of a transmission is to be used by a sensing node for sensing properties to determine presence of an object and/or to localize location of the object. The circuitry is further operative to send control signaling that indicates at least which part of the transmission is to be used by the sensing node for the sensing of properties to determine presence of the object and/or to localize location of the object.

Some other related embodiments are directed to a method performed by a system comprising a sensing node and a control node. The method includes determining, at the control node, which part of a transmission is to be used by the sensing node for sensing properties to determine presence of an object and/or to localize location of the object. The method sends, from the control node, control signaling that indicates at least which part of the transmission is to be used by the sensing node for the sensing of properties to determine presence of the object and/or to localize location of the object. The method receives, at the sensing node, the control signaling from the control node that indicates which part of a transmission is to be used for sensing. The method decodes, at the sensing node, a received transmission from the control node to obtain user plane data and/or control plane data. The method senses properties of the part of the received transmission indicated by the control signaling, to determine presence of an object and/or to localize location of the object.

Some other related embodiments are directed to a system including a sensing node and a control node. The control node includes circuitry operative to determine which part of a transmission is to be used by the sensing node for sensing properties to determine presence of an object and/or to localize location of the object, and send control signaling that indicates at least which part of the transmission is to be used by the sensing node for the sensing of properties to determine presence of the object and/or to localize location of the object. The sensing node includes circuitry operative to receive the control signaling from the control node that indicates which part of a transmission is to be used for sensing, decode a received transmission from the control node to obtain user plane data and/or control plane data, and sense properties of the part of the received transmission indicated by the control signaling, to determine presence of an object and/or to localize location of the object.

As will be explained in further detail below, potential benefits provided by these and further embodiments disclosed herein can include that they provide a signaling and protocol configuration for resource allocation and multiplexing of data transmissions with sensing transmissions within the JCAS framework The embodiments may improve the ability of a control node to configure a sensing node to know what part of a transmission is to be used for sensing properties to determine presence of an object and/or to localize location of the object, while also knowing what same or other part of the transmission is to be used to perform decoding of user plane data and/or control plane data. The structured control enables more accurate operation of sensing node.

Other sensing nodes, control nodes, systems, methods, computer programs, and computer program products according to embodiments of the inventive subject matter will be or become apparent to one with skill in the art upon review of the following drawings and detailed description. It is intended that all such additional sensing nodes, control nodes, systems, methods, computer programs, and computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIGS. 1a, 1b, 1c, 1d, 1e, and 1f illustrate different radar settings that can be deployed using New Radio (NR) BS(s), denoted by gNB, and UE(s);

FIGS. 2a and 2b illustrate BS-based monostatic sensing, and FIG. 2c illustrates UE-based monostatic sensing;

FIG. 3 illustrates a control signaling operation which allocates transmission resource R used for transmitting or receiving data or control information and for sensing using the same transmission as was transmitted or received, in accordance with some embodiments of the present disclosure;

FIG. 4 illustrates a control signaling which allocates transmission resources where subset transmission resource A is the sensing part and subset transmission resource B is the non-sensing part, in accordance with some embodiments of the present disclosure;

FIG. 5 illustrates periodically allocated resources for transmissions with orthogonal sensing and non-sensing part in accordance with some embodiments of the present disclosure;

FIG. 6 illustrates periodically allocated resources (parts) for transmissions with orthogonal sensing and non-sensing part, each with separate periodicity in accordance with some embodiments of the present disclosure;

FIG. 7 illustrates control signaling that allocates dynamic grant for data transmission resources and recurring resources for sensing operation, in accordance with some embodiments of the present disclosure;

FIG. 8 illustrates a flowchart of operations that can be performed by a sensing node in accordance with some embodiments;

FIG. 9 illustrates a flowchart of operations that can be performed by a control node in accordance with some embodiments; and

FIG. 10 illustrates components of a sensing node 1000 and/or a control node 1002 which are configured to operate in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present or used in another embodiment.

Some embodiments of the present disclosure are directed to mechanisms where the existing signaling procedures are modified, supplemented or repurposed to support sensing signal transmissions within the joint communications and sensing (JCAS) framework in addition to communication data transmissions.

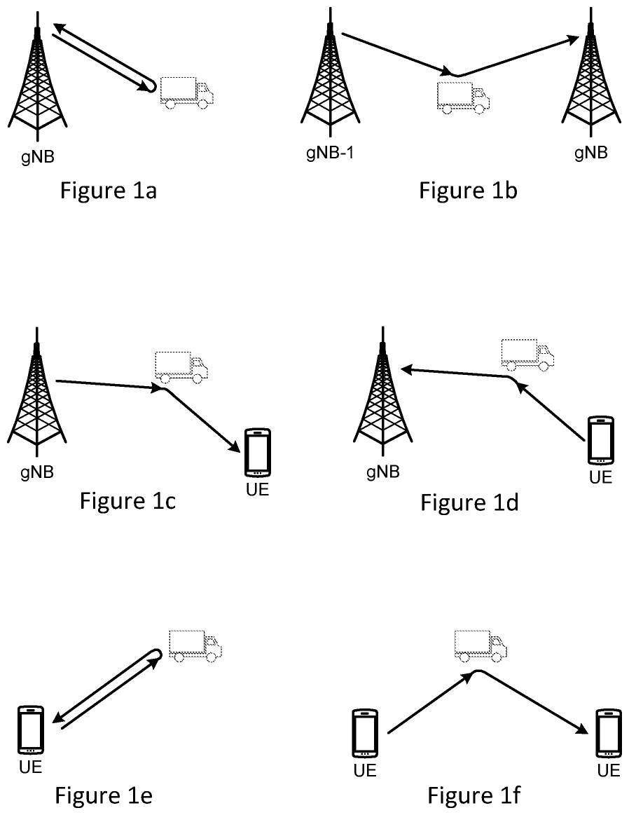

These and other embodiments are directed to the sensing modes involving either both the user equipment (UE) and the base station (BS) (see modes 3 and 4 in FIG. 1) or only BS (Mode 1 in FIG. 1), in the monostatic sensing setting (Mode 1 in FIG. 1). In some other embodiments, the nodes may both be UEs such that one UE senses based on signalling from another UE, and the sensing UE performs the sensing based on parts(s) of a received transmission that have been scheduled or otherwise indicated by the other UE to be used for sensing.

Some embodiments provide a signaling and protocol configuration for resource allocation and multiplexing of data transmissions with sensing transmissions within the JCAS framework. An example is where a gNB (which is also a sensing transmitter node) sends a Physical Downlink Shared Channel (PDSCH) (containing data), which is received by a sensing receiver node. The sensing receiver node performs two processes: (1) decodes the data; and (2) records the passive UE context (based on reflections of PDSCH transmission from the passive object).

In one embodiment, a transmission is configured to contain control plane data and/or user plane data (information), and is also configured to be utilized for sensing purposes. For example, when a first node N1 (e.g., a first one of BS (gNB) and UE, or a first UE among first and second UEs) transmits to a second node N2 (e.g., the other one of BS (gNB) and UE, or the second UE among the first and second UEs), the second N2 performs the following two operations on the received transmissions, which can be performed concurrently or sequentially in either order:
1. Decodes the transmission to obtain user plane data and/or control plane data and can pass it to a higher layer (if applies); and
2. Records or analyzes the properties of the transmission for sensing purposes. The properties being analyzed may be related to power, energy, doppler shift, multi-path components, phase shift, time, frequency, spatial properties, some other physical properties (e.g., material), etc. which can be operationally used to sense (e.g., detect, localize, etc.) the sensing target, a neighboring node, or the environment.

A first node which provides resource scheduling to a second node that defines what part of a received transmission(s) is to be used by the second node for sensing, is also referred to as a “control node.” The second node which senses properties of the part of the received transmission defined by the resource scheduling, to determine presence of an object and/or to localize location of the object, is also referred to as a “sensing node.” Although some embodiments will be described in the context of the control node being a network node, such as a gNB, the control node may be a UE or any other node. Similarly, the sensing node will be described mainly in the context of being a UE, although the sensing node may be a network node or any other node.

FIG. 9 illustrates a flowchart of operations that can be performed by a control node in accordance with some embodiments. Referring to FIG. 9, the control node determines 900 which part of a transmission is to be used by a sensing node for sensing properties to determine presence of an object and/or to localize location of the object. The control node sends 902 control signaling that indicates at least which part of the transmission is to be used by the sensing node for the sensing of properties to determine presence of the object and/or to localize location of the object.

The control node or another node may then send 904 a transmission containing the part indicated by the control signalling to be used for the sensing and further containing user plane data and/or control plane data.

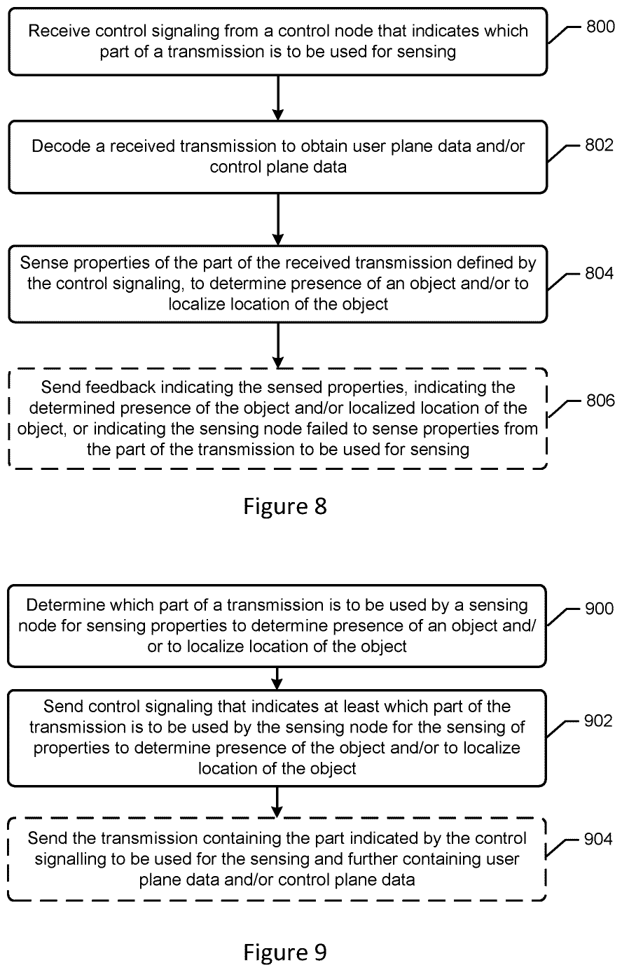

FIG. 8 illustrates a flowchart of operations that can be performed by a sensing node in accordance with some embodiments. Referring to FIG. 8, the sensing node receives 800 control signaling from a control node that indicates which part of a transmission is to be used for sensing. The sensing node decodes 802 a received transmission to obtain user plane data and/or control plane data, and senses 804 properties of the part of the received transmission indicated by the control signaling, to determine presence of an object and/or to localize location of the object. In some optional further embodiments as described further below, the control node may send 806 feedback, e.g., to the control node or another node, indicating the sensed properties, indicating the determined presence of the object and/or localized location of the object, or indicating the sensing node failed to sense properties from the part of the transmission to be used for sensing.

In a further operational embodiment by the control node, the control signaling indicates which part of the transmission is to be used by the sensing node for the sensing at least one of: power of the part of the transmission indicated by the control signaling; energy of the part of the transmission indicated by the control signaling; doppler shift of the part of the transmission indicated by the control signaling; multi-path components of the part of the transmission indicated by the control signaling; phase shift of the part of the transmission indicated by the control signaling; time of reception of the part of the transmission indicated by the control signaling; frequency of the part of the transmission indicated by the control signaling; and spatial properties of the part of the transmission indicated by the control signaling. In a corresponding further operational embodiment by the sensing node, the sensing senses at least one of: power of the part of the received transmission indicated by the control signaling; energy of the part of the received transmission indicated by the control signaling; doppler shift of the part of the received transmission indicated by the control signaling; multi-path components of the part of the received transmission indicated by the control signaling; phase shift of the part of the received transmission indicated by the control signaling; time of reception of the part of the received transmission indicated by the control signaling; frequency of the part of the received transmission indicated by the control signaling; and spatial properties of the part of the received transmission indicated by the control signaling.

The sensing by the sensing node may be performed at the physical layer without using result of the operation decoding the received transmission.

In a further embodiment, the transmissions can be any one or more of the following types:
1. Shared channel based, i.e., Physical Uplink Shared Channel (PUSCH) or Physical Downlink Shared Channel (PDSCH) or SideLink Shared Channel (SLSCH);
2. Control channel based, i.e., Physical Downlink Control Channel (PDCCH) or Physical Uplink Control Channel (PUCCH) or SideLink Control Channel (SLCCH);
3. Radio Resource Control (RRC) signaling, such as System Information Blocks (SIBs);
4. Signaling over broadcast channel, such as Physical Broadcast Shared Channel (PBSCH);
5. Paging or Paging channel; and
6. Other signaling, such as Non Access Stratum (NAS) signaling.

For the sensing operation, the whole transmission may not be needed to perform the sensing. Instead, only a part or a subset of the transmission is operationally used for sensing. The part or subset of the transmission used for sensing may be any one or more of the following:
1. DeModulation Reference Signal (DMRS);
2. Special (defined) sequences embedded in the transmission;
3. Special signaling multiplexed with transmission, such as where only special defined signaling is monitored or recorded for sensing; and
4. defined number X of symbols or slots would be targeted for sensing from the transmission. For example, a first symbol of a PDSCH Transport Block (TB) which spans over more than one symbol, may be used for sensing.

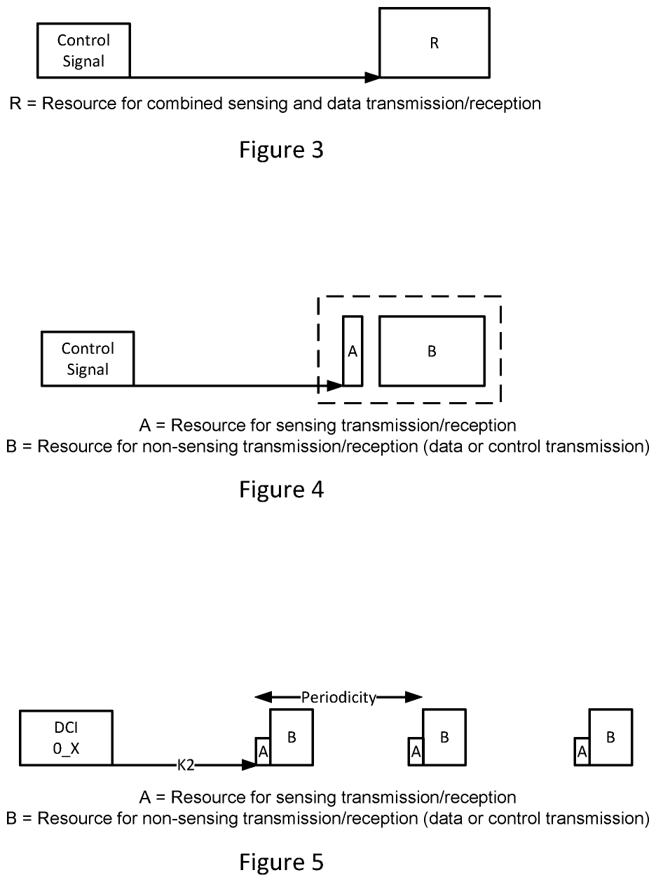

In one embodiment, the control signaling from a control node can allocate the resource for transmission where the resource allocation can be configured as a whole to receive a transmission where the full transmission (Data, control, Uplink Control Information (UCI), Downlink Control Information (DCI), Sidelink Control Information (SCI), or TB) is used for communicating data or control information and used for sensing, such as shown in the example illustration of FIG. 3. Thus, the control signalling can be sent in at least one of: UCI, DCI, SCI, and TB.

FIG. 3 illustrates a control signaling operation which allocates transmission resource R that is used for transmitting or receiving data or control information and is used for sensing using the same transmission as was transmitted or received. In FIG. 3, the transmission on resource R can be used for performing a sensing operation in addition to data or control information transmission or reception.

In another embodiment, the control signaling from a control node can allocate the resource for transmission where the resource allocation can be configured as bifurcated into two or more parts (or subsets) with one part of the transmission is to be decoded to obtain data or control bits only (without sensing properties), and another part of the transmission is to have its properties sensed only (without attempting to decode to obtain data or control bits).

Thus, the sensing node can be operative to determine based on the control signaling that one part of the received transmission is to be decoded to obtain user plane data and/or control plane data, and is not to be used for performing sensing of the properties of the part. The sensing node can be further operative to determine based on the control signaling that another part of the received transmission is to have its properties sensed to determine presence of the object and/or to localize location of the object, and is not to be used to attempt to decode to obtain user plane data and/or control plane data.

FIG. 4 illustrates control signaling which allocates transmission resources where subset transmission resource A is the sensing part which is to have its properties sensed (without performing operations to attempt to decode to obtain data or control bits), and subset transmission resource B is the non-sensing part which is to be decoded to obtain data or control bits (without performing operations to sense its properties). In FIG. 4, the control signaling can be explicit signaling from another node or it could be implicit signaling, such as the node's internal configuration dictating where it can locate transmission resource, e.g., some RRC configuration or some configuration stored in the UE's memory.

In a further operational embodiment by the control node, the control signaling indicates one part of the transmission is to be decoded to obtain user plane data and/or control plane data, and is not to be used for performing sensing of the properties of the part, and another part of the received transmission is to have its properties sensed to determine presence of the object and/or to localize location of the object, and is not to be used to attempt to decode to obtain user plane data and/or control plane data. In a corresponding further operation embodiment by the sensing node, it determines based on the control signaling that one part of the received transmission is to be decoded to obtain user plane data and/or control plane data, and is not to be used for performing sensing of the properties of the part, and determines based on the control signaling that another part of the received transmission is to have its properties sensed to determine presence of the object and/or to localize location of the object, and is not to be used to attempt to decode to obtain user plane data and/or control plane data.

In a further embodiment, for a part of a transmission which is to be only utilized for sensing, the part of the transmission can be defined to contain only dummy bits (i.e., bits not representing user data bits or control data bits) or padding bits (i.e., bits added (padded) to the length of user data bits or control data bits, e.g., of a packet, without the padded bits themselves representing user data bits or control data bits), or can be defined to contain a defined one or more sequences which are pre-configured by the network for sensing purpose. Thus, in a further operational embodiment by the control node, the control signaling indicates that the sensing is to be performed on at least one of the following in the transmission: dummy bits of the part of the transmission indicated by the control signaling; padding bits of the part of the transmission indicated by the control signaling; and a defined one or more sequences of the part of the transmission indicated by the control signaling, which are pre-configured by the control node for sensing operations.

In a further embodiment, a control signal (RRC or DCI or SCI based) can configure resources for the sensing node for reception of transmissions, including which part(s) of the of the reception are to be used to sense properties for the sensing operations.

The resources (parts of the transmission) may be allocated dynamically, such as single-allocation or multi-allocation, e.g., for multi-PUSCH or multi-PDSCH grant. Alternatively, the resources may be allocated by configuration indicating Semi-Persistent Scheduling (SPS), Configured Grant (CG), Small Data Transmission (SDT)-CG based (over Uu or PC5 interface). In a corresponding operational embodiment by the control node, the control signaling indicates that the part of the transmission to be used for sensing is either a single-allocation for only the transmission or a multi-allocation for the transmission and at least one other transmission. The control signaling may indicate the part of the transmission to be used for sensing is allocated by semi-persistent scheduling, a configuration grant, or a small data transmission configuration grant. The sensing node can be operative to determine based on the control signaling that the part of the transmission to be used for sensing is either a single-allocation for only the received transmission or a multi-allocation for the received transmission and at least one other transmission to be received. The sensing node can be operative to determine based on the control signaling that the part of the transmission to be used for sensing is allocated by semi-persistent scheduling, a configuration grant, or a small data transmission configuration grant.

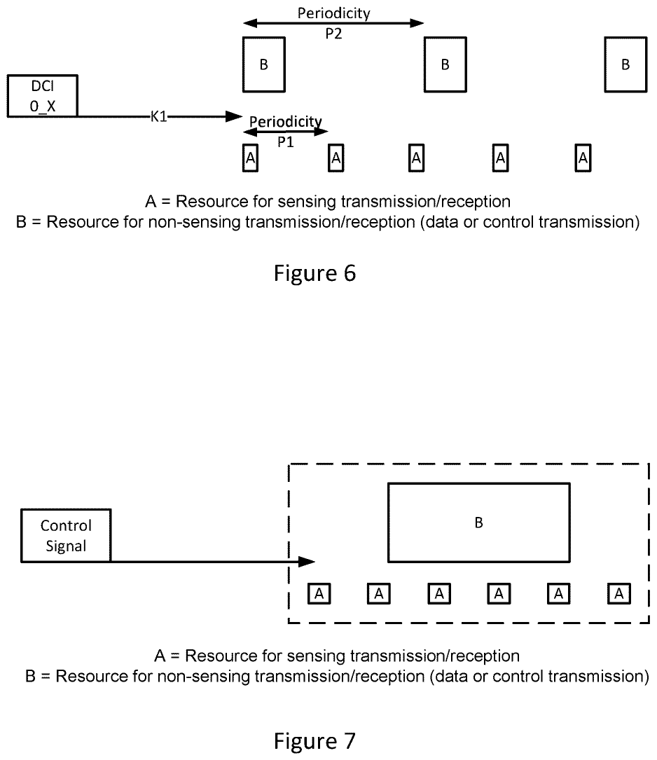

Two examples of such allocation are illustrated in FIGS. 5 and 6, where sensing and non-sensing transmission resources are bifurcated and periodically allocated. FIG. 5 illustrates periodically allocated resources for transmissions with orthogonal sensing and non-sensing part. FIG. 6 illustrates periodically allocated resources (parts) for transmissions with orthogonal sensing and non-sensing part, each with separate periodicity. It is noted that resources of transmissions with orthogonal sensing and non-sensing parts can have different periodicities, e.g., transmissions of part(s) used for sensing can have different transmission event periodicity than transmissions of part(s) used for user plane data and/or control plane data.

In one embodiment, the control node (e.g., network node) can allocate a combination of dynamic resources for data transmissions and finite recurring resources for sensing part, e.g., as shown in FIG. 7. FIG. 7 illustrates control signaling that allocates dynamic grant for data transmission resources and recurring resources for sensing operation. In these recurring resources, the transmissions can itself be any of: 1) data segments or parts which are used for sensing operations; 2) sequences or Demodulation Reference Signals (DMRSs) which are used for sensing operations; and 3) non-data transmissions which are only used for sensing operations.

In some embodiments, the sensing node provides feedback indicating the properties that have been sensed from the received transmission or from a plurality of received transmissions. The feedback may be sent from the sensing node to the control node and/or to another node (e.g., system network node, gNB, UE, etc.) of the system. In one example embodiment, feedback can include feedback indicating the properties sensed from the data part and/or control part of the transmission, and/or indicating the presence of the object and/or localization of location of the object determined from the properties sensed. The feedback may be provided as part of a Hybrid Automatic Repeat Request (HARQ) ACK or NACK for data transmission (PDSCH TB), and/or provided as part of a Medium Access Control (MAC) Control Element (CE) based acknowledgement for activation or release of SPS/CG. In another example embodiment, the feedback can include feedback on the properties sensed from the sensing part of the transmission, and/or indicating the presence of the object and/or localization of location of the object determined from the properties sensed.

In a corresponding operational embodiment, the sensing node sends feedback indicating properties sensed from the part of the received transmission indicated by the control signaling, and/or feedback indicating presence of the object and/or localization of location of the object determined from the properties sensed.

In some embodiments, the sensing node can indicate that it failed to sense properties from the part of the transmission to be used for sensing. In some further embodiments, the sensing node performs the sending of the feedback indicating the sensing node failed to sense properties from the part of the transmission to be used for sensing, responsive to at least one of:
1. determining that power of the part of the received transmission indicated by the control signaling, does not satisfy a defined rule;
2. determining that energy of the part of the received transmission indicated by the control signaling, does not satisfy a defined rule;
3. determining that doppler shift of the part of the received transmission indicated by the control signaling, does not satisfy a defined rule;
4. determining that multi-path components of the part of the received transmission indicated by the control signaling, do not satisfy a defined rule;
5. determining that phase shift of the part of the received transmission indicated by the control signaling, does not satisfy a defined rule;
6. determining that time of reception of the part of the received transmission indicated by the control signaling, does not satisfy a defined rule;
7. determining that frequency of the part of the received transmission indicated by the control signaling, does not satisfy a defined rule; and
8. determining that spatial properties of the part of the received transmission indicated by the control signaling, do not satisfy a defined rule.

In a similar operational embodiment, the control node determines from the feedback by the sensing node at least one of:
1. power of the part of the received transmission indicated by the control signaling, does not satisfy a defined rule;
2. energy of the part of the received transmission indicated by the control signaling, does not satisfy a defined rule;
3. doppler shift of the part of the received transmission indicated by the control signaling, does not satisfy a defined rule;
4. multi-path components of the part of the received transmission indicated by the control signaling, do not satisfy a defined rule;
5. phase shift of the part of the received transmission indicated by the control signaling, does not satisfy a defined rule;
6. time of reception of the part of the received transmission indicated by the control signaling, does not satisfy a defined rule;
7. frequency of the part of the received transmission indicated by the control signaling, does not satisfy a defined rule; and
8. spatial properties of the part of the received transmission indicated by the control signaling, do not satisfy a defined rule.

The following table indicates example feedback outcomes or states which can be communicated by the sensing node using ACK/NACK related transmissions to, e.g., the control node, in accordance with some further embodiments:

Feedback

| State | TB (data transmission) | Sensing reporting |
|---|---|---|
| 1 | ACK | ACK or some report |
| 2 | ACK | NACK or no report |
| 3 | NACK | ACK or some report |
| 4 | NACK | NACK or no report |

In some further embodiments, reporting of the feedback by the sensing node can be sent through channels, which may include one or more of the following:
1. (UCI (e.g., PUCCH);
2. DCI (e.g., PDCCH);
3. Downlink Feedback Indicator (DFI);
4. Configured Grant UCI (CG-UCI);
5. Unused Transmission Occasions-UCI (UTO-UCI);
6. MAC CE (Uplink (UL), Downlink (DL), or SL MAC CE); and
7. physical sidelink feedback channel (PSFCH)

In some further embodiments, the resources R or A and B (i.e., sensing and data transmissions resources) in the above figures which can be allocated by the same or multiple control signaling may have one or more of the characteristic relations shown in the following table:

| Sensing resource/transmission | Data transmission |
|---|---|
| characteristics | resource/transmission characteristics |
| Unicast transmission | Unicast transmission |
| Unicast transmission | Multicast/groupcast transmission |
| Multicast/groupcast transmission | Unicast transmission |
| Multicast/groupcast transmission | Multicast/groupcast transmission |

In one embodiment, control signaling can allocate multicast transmission resource for sensing operation and unicast transmission resource for the data transmission at the same time. An example is, a node sends control signaling to a specific group of UEs, where all the UEs are operable to decode sensing resources and but only one UE amongst the group is operable to decode data transmissions resource. In an example, embodiments, the sensing node is operative to determine from the control signaling that a multicast transmission resource is to be used for the sensing of properties and that a unicast transmission resource is to be used for the decoding to obtain user plane data and/or control plane data.

In one embodiment, the node sending control signaling in order to allocate sensing and data transmission resources can indicate which UEs are allocated with sensing resources and which UEs are allocated with legacy communication resources. In some embodiments, the control node sends to a group of UEs information identifying which of the UEs are to perform sensing of resources. In a corresponding operation, the sensing node operates to determine from information sent by the control node, whether the sensing node is to perform sensing of resources and to selectively perform the sensing responsive to whether the information indicates that the sensing node is to perform the sensing of resources.

The example table below illustrates group cast signaling can indicate the following pattern where the first row indicates shortened identifiers (IDs) of the UEs (or other sensing nodes) in a group, the second row indicates sensing resources which are activated or not activated (bit ‘1’ indicates sensing resources activated and bit “0” indicates sensing resources not activated, or vice-versa), and the third row indicates data resources which are activated or not activated (bit ‘1’ indicates data resources activated and bit “0” indicated data resources not activated, or vice-versa):

| ID#1 | ID#2 | ID#3 | ID#4 | ID#5 | ID#6 | ID#7 | ID#8 | ID#9 | ID#10 |
|---|---|---|---|---|---|---|---|---|---|
| 1 | 0 | 0 | 0 | 0 | 1 | 1 | 1 | 1 | 0 |
| 0 | 0 | 0 | 0 | 1 | 1 | 1 | 1 | 0 | 0 |

For example, in the above embodiment, For UE ID #9, its sensing resources are activated, and data transmission resources are deactivated. UE ID #9 will therefore responsively perform sensing of properties of received transmission(s) and will not decode the received transmission(s) to obtain user plane data and/or control plane data.

It is noted that the signaling can be unicast or multicast or groupcast. The signalling can be sent as PHY layer signaling (DCI) or RRC or system information block (SIB) based.

In one embodiment, which may be an extension of the previous embodiment, the resource of a given UE (or other sensing node) can be used for either operation (sensing of properties operation or data decoding) or both. For instance, if a resource is allocated to UE ID #6, the same resource may be used for the sensing operation and for the data decoding. However, for UE ID #9, the allocated resource can be used for the sensing operation but not data decoding.

In a further embodiment, if the same resource is allocated to a particular UE (for the purpose of receiving or transmitting sensing and data transmission), the transmission can be the same or different relative to the sensing and data part on the same resource.

Some non-limited optional alternative embodiments are now discussed below.

In a further operational embodiment by the control node, the control signaling indicates at least one condition that when satisfies indicates to a sending node that the transmission is to be used for both the decoding and the sensing.

In a further embodiment, if a sensing node, e.g., UE, is in a geographic region where the sensing operation is activated, then the control node, e.g., network node, can configure which data transmissions can be used for the sensing operation or are not to be used for the sensing operation. For example, if a sensing node receives a data transmission, then the sensing node may be configured to use this transmission for sensing properties or can be configured to not use this transmission for sensing properties.

When the data transmission or resources occur over specific resources (e.g., time, frequency, or spatial), then the sensing node can be operational to responsively use the received transmission for both sensing and decoding. The same transmission or set of transmissions can have two parts or elements, one pertaining to data and the other pertaining to sensing.

When the data transmission occurs in a defined location, geographic region, or with a defined timing advance (TA), then the sensing node can be operational to responsively use the received transmission for both sensing and decoding.

The control node may configure the sensing node to response to receipt of transmissions from a specific gNB(s) or a specific other sensing node or control node, by operating to responsively use the received transmission for both sensing and decoding.

Thus, in one embodiment, the sensing node operates to determine that a received transmission is to be used for both the decoding operation and the sensing operation responsive to determining that the received transmission satisfied at least one of the following conditions: 1) used defined resources; 2) occurred at a defined location; 3) occurred in a defined geographic region; and 4) occurred with a defined timing advance.

In some embodiment, the DCI formats are allocated for same DCI formats 0_X and 1_X where X=0, 1, 2 or group common formats 2_Y, or SL formats 3_Z etc. (Y, Z are numerals which are already specified for existing formats). New fields can be added to the existing DCI formats to indicate allocated resources are sensing operations or not. New DCI formats may be used to indicate sensing resource allocation (with or without data transmission resource allocation).

In some embodiments, existing time domain resource allocation (TDRA) tables can be used for specifying resource allocation for sensing-based transmission. Existing TDRA table examples are Pdsch-TimeDomainAllocationList, TimeDomainAllocationListDCI-1-2, pdsch-TimeDomainAllocationListForMultiPDSCH-r17, pusch-TimeDomainAllocationList, pusch-TimeDomainAllocationListDCI-0-1, pusch-TimeDomainAllocationListForMultiPUSCH-17, etc. (these tables are specified in the 3GPP TS 38 series, e.g., 3GPP TS 38.214 v17.4.0). In another embodiment, new TDRA tables are defined for the sensing transmission related resource allocation.

In one embodiment, JCAS-related transmissions may include (non-sensing) communication signals (data signals, pilot signals, control information) as well as sensing signals (sensing pilot signals, sensing control information), assuming communication and sensing signals or channels are different, and the transmissions can be sent multiplexing together.

In some embodiments, the sensing node (e.g., UE) is equipped with an onboard sensor and can send sensing-related information to the network for JCAS operation. Specifically, the control node (e.g., network node) can define capabilities for such UEs (which have on-board sensor or capability to perform JCAS operation), and UE can report such capability. The capability can also be defined as UE feature or device type or category.

Examples of vehicle-based measurements are displacement readings from inertial measurement unit (IMU) sensors, and barometer pressure sensors for altitude computation and reporting.

In some other embodiment, the user/control data transmission and the sensing transmission are separated spatially allowing to transmit sensing and communication data simultaneously in time.

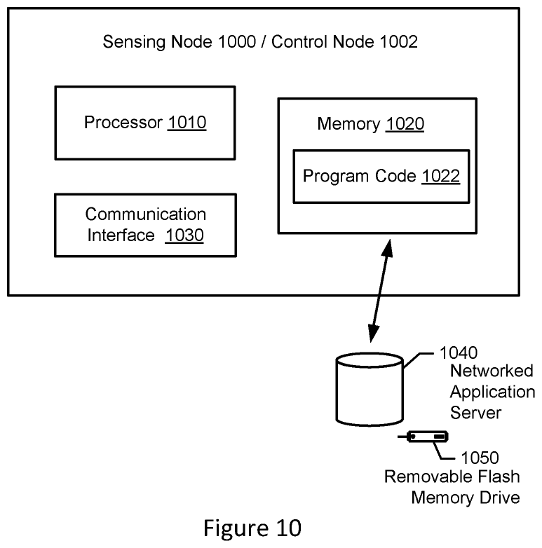

FIG. 10 illustrates components of a sensing node 1000 and/or a control node 1002 which can be configured to operate according to any one or more of the embodiments disclosed herein. The sensing node 1000 and/or control node 1002 can include at least one processor circuit 1010 (processor), at least one memory circuit 1020 (memory), at least one communication interface circuit 1030 (communication interface). The processor 1010 is operationally connected to these various components. The memory 1020 stores program code 1022 (also referred to as “computer program comprising computer-executable instructions”) that is executed by processor 1010 to perform operations and methods according to any one or more of the embodiments disclosed herein for sensing nodes and/or control nodes. The processor 1010 may include one or more data processing circuits, such as a general purpose and/or special purpose processor circuits (e.g., microprocessor and/or digital signal processor), which may be collocated or distributed across one or more data networks.

FIG. 10 further illustrates non-limiting examples of a computer readable medium, which can include any one or more of the memory 1020, a networked application server 1040, a removable flash memory drive 1050 (e.g., USB flash drive) or other removable memory, e.g., CD, DVD, etc.

In some embodiment, different configuration sources can be used to assist sensing configurations.

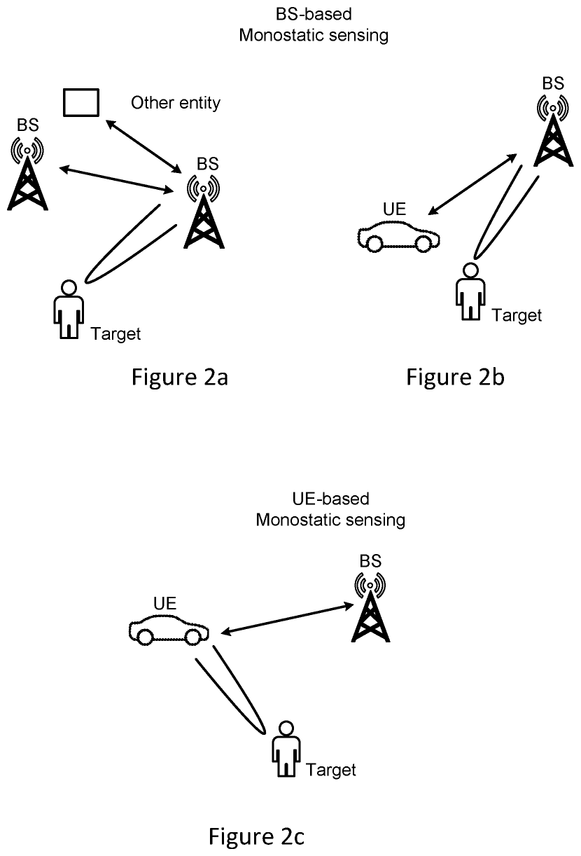

FIGS. 2a and 2b illustrate BS-based monostatic sensing, and FIG. 2C illustrates UE-based monostatic sensing. Similar assistance sources can be used for bi-static and multi-static scenarios. It is noted that the configurations of the sensing signals may be performed jointly with respect to the data communications in any scenario where the same node (UE or BS) is involved in both communication and sensing. It is noted that prior-existing NR framework does not allow to configure data/sensing signal transmission/reception jointly.

In some embodiment, sensing signals are configured based on some information from some other gNB(s), as depicted in FIG. 2a.

In some embodiment, sensing signals are configured based on some other external entity such as a core/cloud or other entity managing the sensing service (e.g., which may be similar to the location management function in cellular positioning), as depicted in FIG. 2a. In this case, the information to assist sensing is sent through interfaces such as Xn, Ng or other new interface for supporting sensing.

In some embodiment, sensing signals are configured based on some communications information received by the gNB, as depicted in FIG. 2b. This information can include the UE's velocity, beam ID, or some onboard sensor measurement reports. It should be noted that communication parameters can be chosen based on the sensing information: for example, if operations detect a certain speed of the UE, they may define a corresponding periodicity for the sensing signals, and which will impact the available resources for data or communication signals based on the periodicity.

In some embodiments, the gNB configures the sensing signals sent by the UE based on the communication link information via for example Uu interface, as depicted in FIG. 2c. The UE can configure the UL data transmissions taking into account the resources needed for sensing. The configuration provided by the network to the UE can be performed in a similar way as in mode 1 SideLink (SL) resource allocation but, in the present embodiment, the resources are used by the UE for sensing instead of communication with another UE in SL.

Further definitions and embodiments are now explained below.

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The term “transmit” is used herein to refer to an operation by a node to transmit through a transmitter circuit-to-air interface or to transmit through a network interface to cause another node to transmit through a transmitter circuit-to-air interface. Similarly, the term “receive” is used herein to refer to an operation by a node to receive through an air-to-receiver circuit interface or to receive through a network interface from another node that receives through an air-to-receiver circuit interface.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item and is not intended to be limiting of such item. The common abbreviation “i.e.”, which derives from the Latin phrase “id Est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents and shall not be restricted or limited by the foregoing detailed description.

The enumerated references made above are defined below:
[1] 3GPP S1-220191 “Study on Integrated Sensing and Communication”, 3GPP WI Description, SA WG1 (Release 19), February 2022.
[2] 3GPP TR 22.837, “Feasibility Study on Integrated Sensing and Communication”, Technical report, TSG SA (Release 19), May 2022.
[3] 3GPP RP-223114, “Study on Integrated Sensing and Communication for NR Rel-19”, Work Item Description, 3GPP 98e, December 2022.

1. A method by a sensing node comprising:
receiving control signaling from a control node that indicates which part of a transmission is to be used for sensing;
decoding a received transmission from the control node to obtain user plane data and/or control plane data; and
sensing properties of the part of the received transmission indicated by the control signaling, to determine presence of an object and/or to localize location of the object.

2. (canceled)

3. The method by the sensing node of claim 1, wherein the sensing properties of the part of the received transmission indicated by the control signaling, to determine presence of the object and/or to localize location of the object, comprises:
performing the sensing at the physical layer without using result of decoding the received transmission.

4-5. (canceled)

6. The method by the sensing node of claim 1, comprising:
determining based on the control signaling that one part of the received transmission is to be decoded to obtain user plane data and/or control plane data, and is not to be used for performing sensing of the properties of the part; and
determining based on the control signaling that another part of the received transmission is to have its properties sensed to determine presence of the object and/or to localize location of the object, and is not to be used to attempt to decode to obtain user plane data and/or control plane data.

7. The method by the sensing node of claim 6, wherein the sensing properties of the part of the received transmission indicated by the control signaling, to determine presence of the object and/or to localize location of the object, comprises:
performing the sensing on at least one of the following in the received transmission:
dummy bits of the part of the received transmission indicated by the control signaling;
padding bits of the part of the received transmission indicated by the control signaling; and
a defined one or more sequences of the part of the received transmission indicated by the control signaling, which are pre-configured by the control node for sensing operations.

8. (canceled)

9. The method by the sensing node of claim 1, comprising:
determining based on the control signaling that the part of the transmission to be used for sensing is allocated by semi-persistent scheduling, a configuration grant, or a small data transmission configuration grant.

10. The method by the sensing node of claim 1, comprising:
sending feedback indicating properties sensed from the part of the received transmission indicated by the control signaling, and/or feedback indicating presence of the object and/or localization of location of the object determined from the properties sensed.

11. The method by the sensing node of claim 1, comprising:
sending feedback indicating the sensing node failed to sense properties from the part of the transmission to be used for sensing.

12. The method by the sensing node of claim 11, wherein the sending feedback indicating the sensing node failed to sense properties from the part of the transmission to be used for sensing, is performed responsive to at least one of:
determining that power of the part of the received transmission indicated by the control signaling, does not satisfy a defined rule;
determining that energy of the part of the received transmission indicated by the control signaling, does not satisfy a defined rule;
determining that doppler shift of the part of the received transmission indicated by the control signaling, does not satisfy a defined rule;
determining that multi-path components of the part of the received transmission indicated by the control signaling, do not satisfy a defined rule;
determining that phase shift of the part of the received transmission indicated by the control signaling, does not satisfy a defined rule;
determining that time of reception of the part of the received transmission indicated by the control signaling, does not satisfy a defined rule;
determining that frequency of the part of the received transmission indicated by the control signaling, does not satisfy a defined rule; and
determining that spatial properties of the part of the received transmission indicated by the control signaling, do not satisfy a defined rule.

13. The method by the sensing node of claim 1, comprising:
determining from the control signaling that a multicast transmission resource is to be used for the sensing of properties and that a unicast transmission resource is to be used for the decoding to obtain user plane data and/or control plane data.

14-15. (canceled)

16. A method by a control node comprising:
determining which part of a transmission is to be used by a sensing node for sensing properties to determine presence of an object and/or to localize location of the object; and
sending control signaling that indicates at least which part of the transmission is to be used by the sensing node for the sensing of properties to determine presence of the object and/or to localize location of the object.

17. The method by the control node of claim 16, comprising:
sending the transmission containing the part indicated by the control signalling to be used for the sensing and further containing user plane data and/or control plane data.

18. (canceled)

19. The method by the control node of claim 16, wherein the control signaling indicates at least one of the following is to be used for the sensing:
DeModulation Reference Signal, DMRS, of the transmission;
a defined sequence embedded in the transmission; and
a defined number of symbols or slots in the transmission.

20. (canceled)

21. The method by the control node of claim 16, wherein the control signaling indicates:
one part of the transmission is to be decoded to obtain user plane data and/or control plane data, and is not to be used for performing sensing of the properties of the part; and
another part of the received transmission is to have its properties sensed to determine presence of the object and/or to localize location of the object, and is not to be used to attempt to decode to obtain user plane data and/or control plane data.

22. The method by the control node of claim 21, wherein the control signaling indicates that the sensing is to be performed on at least one of the following in the transmission:
dummy bits of the part of the transmission indicated by the control signaling;
padding bits of the part of the transmission indicated by the control signaling; and
a defined one or more sequences of the part of the transmission indicated by the control signaling, which are pre-configured by the control node for sensing operations.

23. The method by the control node of claim 16, wherein the control signaling indicates that the part of the transmission to be used for sensing is either a single-allocation for only the transmission or a multi-allocation for the transmission and at least one other transmission.

24. The method by the control node of claim 16, wherein the control signaling indicates that:
the part of the transmission to be used for sensing is allocated by semi-persistent scheduling, a configuration grant, or a small data transmission configuration grant.

25. The method by the control node of claim 16, comprising:
receiving feedback indicating properties sensed by the sensing node from the part of the transmission indicated by the control signaling, and/or feedback indicating presence of the object and/or localization of location of the object determined from the properties sensed by the sensing node.

26. The method by the control node of claim 16, comprising:
receiving feedback indicating the sensing node failed to sense properties from the part of the transmission to be used for sensing.

27-28. (canceled)

29. The method by the control node of claim 16, wherein the control signaling indicates to a group of sensing nodes which of the sensing anodes are to perform the sensing of properties.

30. (canceled)

41. A system comprising a sensing node and a control node, wherein:
the control node comprises circuitry operative to
determine which part of a transmission is to be used by the sensing node for sensing properties to determine presence of an object and/or to localize location of the object, and
send control signaling that indicates at least which part of the transmission is to be used by the sensing node for the sensing of properties to determine presence of the object and/or to localize location of the object; and
the sensing node comprises circuitry operative to
receive the control signaling from the control node that indicates which part of a transmission is to be used for sensing;
decode a received transmission from the control node to obtain user plane data and/or control plane data; and
sense properties of the part of the received transmission indicated by the control signaling, to determine presence of an object and/or to localize location of the object.

42. (canceled)
